(19) United States
(12) Patent Application Publication
(10) Pub. No.: US 2015/0215569 A1
(43) Pub. Date: Jul. 30, 2015

(54) PROJECTOR WITH LIGHT SOURCE INCLUDING LASER, PHOSPHOR, AND LED

(71) Applicant: Wavien, Inc., Valencia, CA (US)

(72) Inventor: Kenneth LI, Castaic, CA (US)

(21) Appl. No.: 14/609,067

(22) Filed: Jan. 29, 2015

Related U.S. Application Data
(60) Provisional application No. 61/933,003, filed on Jan. 29, 2014.
(60) Provisional application No. 61/938,393, filed on Feb. 11, 2014.

(51) Int. Cl. H04N 5/74; G09G 5/02

(52) U.S. Cl. CPC H04N 5/7416; H04N 5/7475; G09G 5/02; H04N 2005/7483

(57) ABSTRACT

A projector includes a laser for forming blue or UV light and a rotatable color wheel having at least one sector coated with a phosphor for converting such blue or UV light into green light. The projector further includes a source of red light and a source of blue light which, in certain embodiments, is the color wheel. At least one imaging device is positioned to receive, directly or indirectly, the green, red and blue light for forming a green, red, and blue portions of an image to be projected. The projector further has projection optics for receiving the green, red, and blue portions for projecting the image. The projection optics may receive sequential green, red, and blue portions of the image to be projected or the green, red, and blue portions can be formed by separate light sources and combined into the final image and projected.

### CROSS-REFERENCE TO RELATED APPLICATIONS

The present application claims priority on U.S. provisional patent application No. 61/933,003, filed on Jan. 29, 2014, and on U.S. provisional patent application No. 61/938,393, filed on Feb. 11, 2014.

### BACKGROUND OF THE INVENTION

The present invention relates to projectors for use in projecting images such as static images as well as non-static images for use in televisions and movies. FIG. 1 shows an example of a projector which includes a light source 10 which projects white light through a color wheel 12. The color wheel 12 typically includes multiple sectors, each sector having one of the three additive colors (red, green, and blue). The color wheel 12 rotates about an axis 14 such that sequential sectors of red, green, and blue rays are produced.

The outputs from the color wheel are projected through relay lenses 16 to projection optics which include a digital micromirror device 18 and a projection lens 20. The micromirror device 18 has small mirrors which correspond to each pixel of the image to be displayed. In use, the micromirror device 18 receives sequentially the red, green, and blue colors. For each color, the mirrors are controlled either to transmit the color for the pixel to the projection lens 20 or to a heat sink 19, to create a partial image corresponding to the color currently being received.

In operation, as the color wheel rotates, pulses of red, green, and blue light are sequentially transmitted to the micromirror device 18, which transmits the appropriate signal for each pixel. The color signals are then projected by the projection lens 20 to form the image. The three different color signals are projected quickly enough that a viewer's eye sees the image as a multi-color single image.

In the past, the principal light source used in projectors has been a replaceable high-pressure xenon arc lamp unit. More recently, projectors have been produced which use high-power LEDs as the source of light. LEDs provide better color and extend the lifetime of the light source. The principal drawback of using LEDs is the lack of sufficient brightness. In some projectors, a light output capability of approximately 2,000 lumens is desired, which is difficult to attain using LEDs as the light source. LEDs do not have the same level of brightness that can be generated with the older arc lamp units. When the size of the LED is matched to the digital panel's etendue, the output is below the desired range.

### SUMMARY OF THE INVENTION

A projector includes a laser for forming blue or UV light and a rotatable color wheel having at least one sector coated with a phosphor for converting such blue or UV light into green light. The projector further includes a source of red light and a source of blue light. In certain embodiments, the red and blue light sources are from phosphors in the other sectors of the color wheel. In other embodiments, the red and blue light sources are LEDs.

At least one imaging device is positioned to receive, directly or indirectly, the green, red and blue light for forming green, red, and blue portions of an image to be projected. The projector further has projection optics for receiving the green, red, and blue portions for projecting the image. The projection optics may receive sequential green, red, and blue portions of the image to be projected or the green, red, and blue portions can be formed by separate light sources and combined into the final image and projected.

In one embodiment, the color wheel has at least three sectors. A second sector is coated with a second phosphor for converting blue light into red light, and a third sector includes a diffuser for transmitting blue light as diffused blue light.

In another embodiment, the red, green, and blue light are transmitted sequentially to a single imaging device. The imaging device is an imaging panel as used in DLP technology for forming and transmitting to the optics, sequentially, the red, green, and blue portions of the image. The image portions are created and displayed quickly enough that a user's eye sees only the complete three-color images.

The invention may employ a light pipe, for example a tapered light pipe, or a compound parabolic concentrator (“CPC”), for receiving the output from the color wheel and transmitting such output towards the imaging panel.

In a further embodiment, the color wheel has at least three sectors. A second sector is opaque and a third sector includes a diffuser for transmitting blue light as diffused blue light. The projector further includes a red LED, which forms the source of red light separate from the laser, and optics for transmitting sequentially red, blue and green light to the imaging device depending upon the rotational position of the color wheel. Thus, the color wheel includes a sector which blocks light from the laser when red light is being transmitted to the imaging device.

Preferably, the red LED is positioned to emit red light generally at an angle to the axial direction of the light from the laser. The projector further includes a filter positioned along the axial direction to reflect red light coming from the red LED to continue in the axial direction while allowing green and blue light from the color wheel to pass through the filter. The red LED is synchronized to emit red light only when the opaque sector of the color wheel blocks light output from the laser.

In another aspect of the invention, the projector includes a plurality of lasers for generating blue or UV light. The lasers all direct their light outputs onto a common location on the color wheel.

According to another embodiment, at least one sector of the color wheel includes a filter element between the laser and the phosphor or diffuser to transmit UV or blue light and reflect green and red light.

The projector can further include a mounting device for the color wheel for changing the position of the color wheel at least vertically. This allows a greater portion of the color wheel to be used and extends the life of the color wheel.

In a further embodiment, a recycling collar, having in inwardly curved reflective surface and an aperture, is positioned to receive the output from the color wheel for passing colored beams through the aperture and reflecting beams that impact the inwardly curved surface back to the color wheel. Recycling of the larger angle emissions from the color wheel improves the efficiency and increases the brightness of the beams sent to the imaging device.

As an alternative to the recycling collar, the color wheel output can be received by a tapered light pipe whose output end includes a reflector for reflecting some of the light back to the color wheel for recycling.

The color wheel may include heat sink elements for absorbing a portion of any heat generated by the UV or blue laser light.

In another embodiment, the projector has a first light source which includes the laser and color wheel for generating only green light. A second, separate light source generates only red light, and a third light source generates only blue light. The outputs from the three light sources pass through an imaging device to create a green, red, and blue portion of an image. The red, blue, and green partial images are combined in a prism, wherein the combined green, red, and blue image portions are projected as a single image.

In another embodiment, the color wheel includes upper and lower faces and a reflective coating on the lower face. The laser transmits blue or UV light through a filter in a first direction to the upper face for forming the green, red, and blue colors, and the color wheel thereafter reflects the colors and transmits the colors back in a direction which is opposite to the first direction. This configuration, in which the laser and color wheel output are on the same side of the color wheel, allows the projector to have a relatively compact design.

### BRIEF DESCRIPTION OF THE DRAWINGS

FIG. 1 is a schematic drawing of a typical image projector;

FIG. 2 is a schematic drawing of a projector according to the invention;

FIG. 3 is a schematic drawing of a color wheel for use in the projectors according to the invention;

FIG. 4 is schematic drawing of an alternative light source according to the invention;

FIG. 5 is a schematic drawing of an alternative embodiment of a color wheel according to the invention;

FIG. 6 is a schematic drawing of a another example of a projector according to the invention;

FIG. 7 is a schematic drawing of another color wheel for use in the projectors of the invention;

FIG. 8 is a schematic drawing of another color wheel for use in the projectors according to the invention;

FIG. 9 is a schematic drawing of another color wheel for use in the projectors of the invention;

FIG. 10 is a schematic drawing of another color wheel for use in the projectors according to the invention;

FIGS. 11 and 12 are schematic drawings of alternative color wheels for use in the projectors according to the invention;

FIG. is a schematic drawing of another projector according to the invention;

FIG. 14 is a schematic drawing of another color wheel according to the invention;

FIG. 15 is a schematic drawing of another color wheel according to the invention; and

FIGS. 16a and 16b are top and cutaway side views, respectively, of two other embodiments of a color wheel and a light source according to the invention.

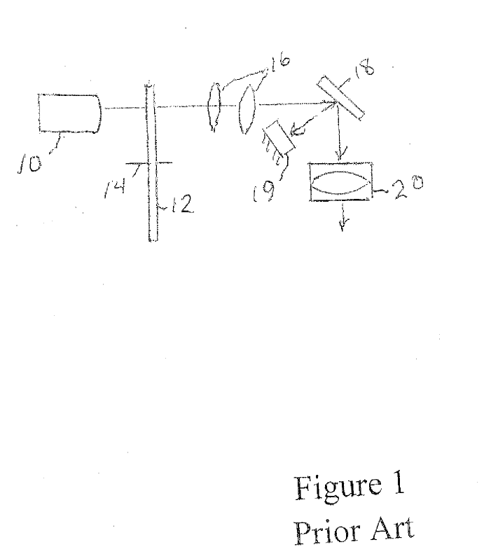

### DETAILED DESCRIPTION OF THE INVENTION

The present invention is a projector which uses a laser as a light source. Because a laser etendue is very small, the limitations caused by using an LED light source are reduced. The laser is preferably a GaN laser which emits a blue light. Other solid state lasers may alternatively be employed for producing the desired wavelength.

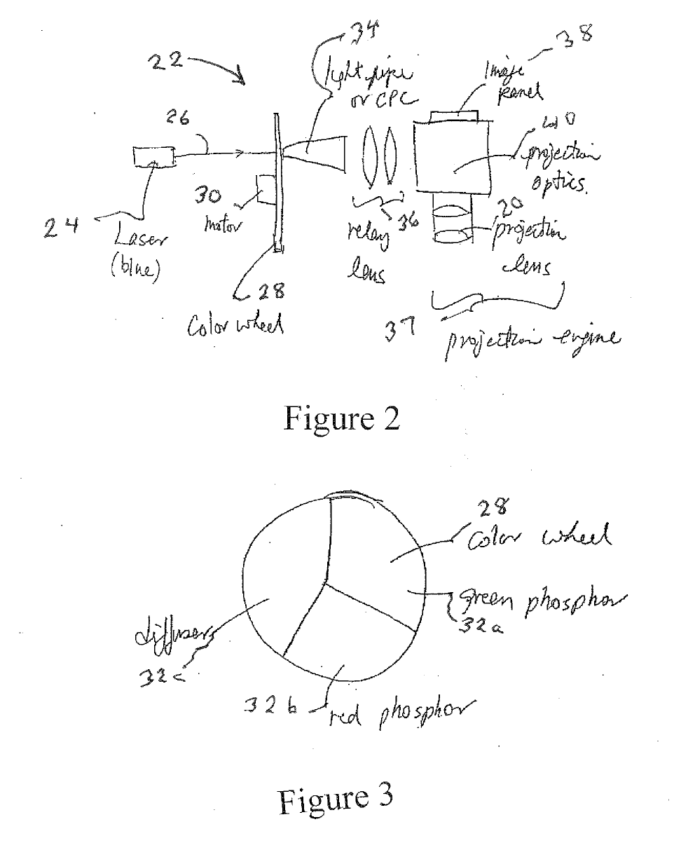

Referring to FIG. 2, a projector 22 includes one or more GaN lasers 24 to produce coherent blue light 26 extending in an axial direction. A color wheel 28, which is rotated by a motor 30 whose output shaft is spaced a distance from the direction of the laser beam, has part of its surface in the path of the laser beam 26.

Light which passes through the color wheel 28 enters a tapered light pipe or a compound parabolic concentrator (“CPC”) 34 having a diameter which increases in the direction of travel of the light ray 26. The light beam 26 is thus transformed from a small cross-sectional area to a larger cross-sectional area by the time it exits the light pipe or CPC 34. The laser beam is transformed from a larger angle of emission to a smaller angle of emission. The light beam output is then directed to pass through a pair of relay lenses 36 into a projection engine 37.

The projection engine 37 includes an image panel 38, which is preferably a digital light processing chip (a micromirror device) or LCOS chip for forming the red, blue, and green image portions to be projected. The projection engine 37 also includes projection optics 40 and a projection lens 20.

FIG. 3 shows an example of a color wheel 28 having three sectors: sector 32a, 32b, and 32c which need not be of the same size. In the example of FIG. 3, sector 32a is a green phosphor, sector 32b is a red phosphor, and sector 32c is a diffuser. The green phosphor of sector 32b absorbs the blue laser light from the laser and emits green light. The red phosphor of the sector 32b absorbs the blue laser light and emits red light. The diffuser of sector 32c scatters the laser light and outputs such light in a predetermined distribution such as Lambertian. As the color wheel rotates to provide sequential color operation, the diffuser of sector 32c also acts a de-speckle mechanism such that the output blue laser light on the screen does not contain speckles.

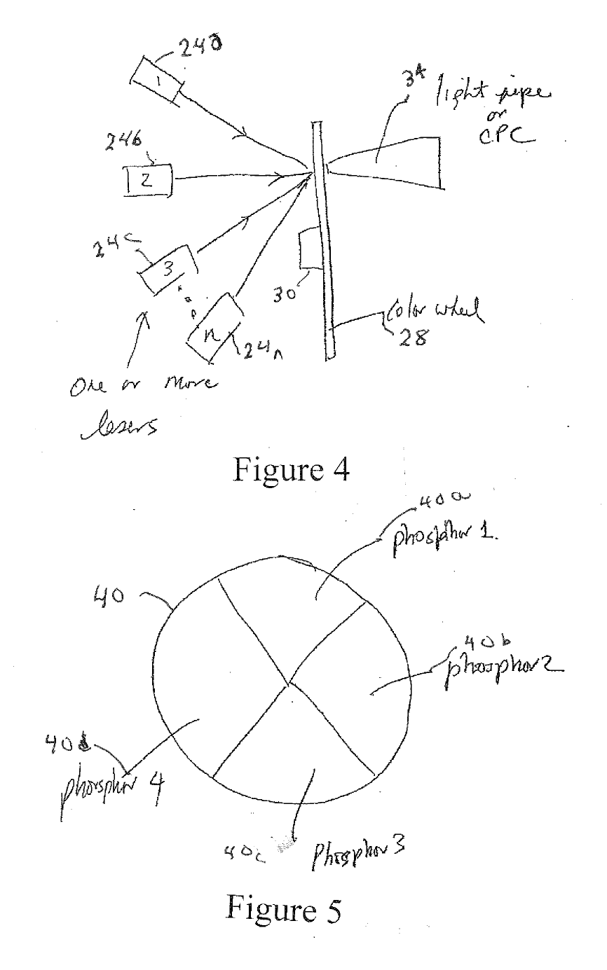

In order to increase the power output, as shown in FIG. 4, multiple lasers 24a, 24b, 24c . . . 24n may be used. All of the lasers 24a-24n point to the same spot on the color wheel. Because the etendue value of the laser is very small, the output from the lasers can be pointed at the same spot on the color wheel 28, thus producing a higher output.

FIG. 5 shows schematically a different color wheel 40 with four sectors 40a, 40b, 40c, and 40d with more than three colors. Each sector thus contains a different color. Alternatively, one of the sectors can include a colorless diffuser e.g., similar to diffuser sector 32c.

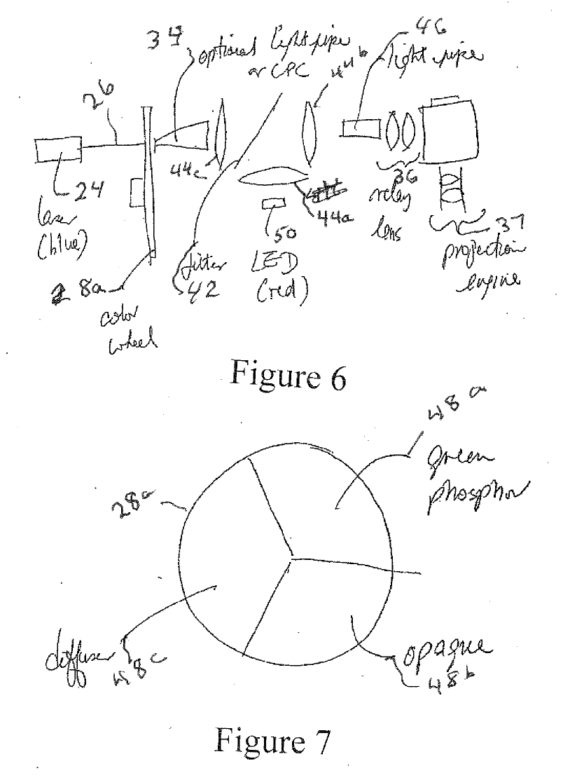

FIG. 6 shows another embodiment of a projector according to the invention. The projector is similar to that shown in FIG. 2, except that a red LED 50 is oriented to output red light in a direction perpendicular to the laser beam 26. The blue output beam 26 from the laser 24, after projecting through a tapered light pipe of CPC 34, passes through a first lens 44c, a filter 42, a second lens 44b, and a straight light pipe 46. The output from the red LED passes through a lens 44a and then impacts the filter 42, which redirects the red light towards the second lens 44a and light pipe 46.

In the system of FIG. 6, the red color for an image is generated by the red LED 50. The color wheel 28a, which is shown in FIG. 7, includes a green phosphor sector 48a, an opaque sector 48b, and a diffuser sector 48c. Similar to FIG. 2, the laser 24 and color wheel 28a generate green light 48a and diffused blue light 48c. The opaque sector 48b blocks light from the laser 24 during the times that the red LED is on, thus providing the red light for the projection engine 37 to generate the red portion of the image. Stated differently, the green portion of the image signal is transmitted when the color wheel 28a is in a rotational position where the green phosphor sector 48a is in the path of the laser light. The blue portion of the image signal is transmitted when the diffuser sector of the color wheel 28a is in the path of the laser light. When the red portion of the image is to be transmitted, the opaque sector 48b of the color wheel 28a is in the path of the laser beam so as to block the beam, and the red LED is turned on. As in the case of FIG. 2, passing the blue laser beam through the diffuser sector 48c reduces the presence of speckles in the blue light. If a higher power output is needed, a plurality of lasers 24a-24n may be employed, similar to FIG. 4.

The red light, generated by using a red LED, is combined with the other light sources generated by the blue laser. The red LED is synchronized such that, when the laser beam is impinged onto the opaque sector 48b of the color wheel, the red LED is turned on.

Alternatively, instead of a red LED and green phosphor, a green LED and a red phosphor can be utilized. In practice, there is usually a lack of green light and, as a result, the laser-pumped phosphor produces more green light than a LED at the same etendue value.

As in known DLP projectors, the red, blue, and green partial images are projected sequentially. The user sees only the complete, three-color image.

The color wheel can contain more than three color sectors. A larger number of sectors will divide the color into finer bands, such that the color gamut can be larger and more accurate image colors can be reproduced.

Although the foregoing embodiments describe a blue laser pumping the phosphor-producing green and red light with longer wavelengths, the same concept can be implemented using a laser which produces red light which pumps another class of phosphors such that the wavelength is up-converted from infra-red to red, green, and blue. In such a case, the diffusing sector 48c is replaced by a blue phosphor.

In the embodiment shown in FIG. 6, where an infra-red laser is used instead of a blue laser, the red LED 50 is replaced with a green or blue LED to provide one of the colors to the projection engine 37 when the infra-red laser beam impacts the opaque portion 48b of the color wheel 28a.

In an alternative embodiment of FIG. 6, the red and blue LED light can be multiplexed with another section of the filter and only the green output is generated by exciting the green phosphor.

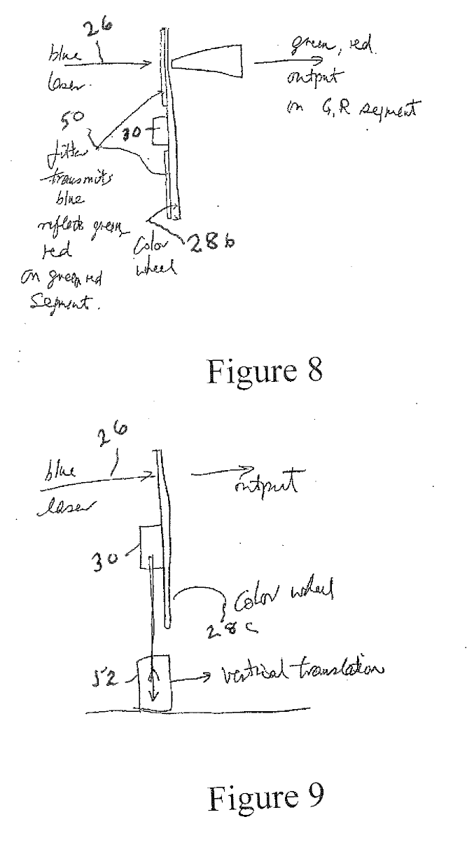

FIG. 8 discloses an alternative embodiment of a color wheel. As shown, collimated light 26 from a laser impacts the color wheel 28b off axis, at a distance from the motor parallel to the axis of rotation of the color wheel 28h. A reflective coating 50 is added to the wheel, on the side facing the light source (UV or blue laser light). The coating transmits the UV or blue light for excitation of the phosphor, but reflects the light emitted by the phosphor. The coating can also be applied onto the diffuser sector of the color wheel if desired.

FIG. 9 shows another embodiment of a color wheel. The motor 30 of the color wheel 28c is mounted on a motor-driven device 52 which can move the color wheel 28c in another direction, for example vertically. In such a color wheel, the phosphors are excited not at just one radius, but at different radii (i.e., radial distances from the motor 30). This allows a larger area of the color wheel to be used. When more phosphor areas are used, a higher overall power can be applied with saturation of the phosphor. This also extends the lifetime of the phosphor. Rather than using an up and down motion, the motor device 52 can apply other types of motion to the color wheel 28c to allow a larger portion of the phosphors to be used.

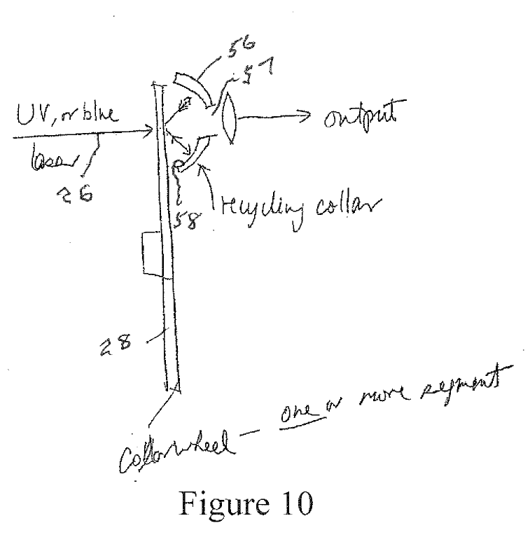

FIG. 10 shows another embodiment of a color wheel system. The color wheel 28 has one or more sectors of light. A one sector color wheel generates only one color. The motor 30 may be mounted on a motor device 52 similar to FIG. 9 to increase the area of the phosphor to be used. Also, a recycling collar 56 is disposed on the opposite side of the color wheel 28 from the light beam 26. The recycling collar 56 has an inwardly curved, e.g. concave, surface 58 facing the color wheel 28 and a central aperture 57 which lies along the light axis upon which the beam 26 travels. The concave surface preferably is spherical or parabolic in shape. The recycling collar 56 increases the brightness by recycling light which is scattered by the phosphor at an angle above a predetermined angle relative to the axis of the UV or blue laser beam 26. Thus, light which impacts on the recycling collar 56 is reflected back onto the color wheel such that the output brightness passing through the aperture is brighter.

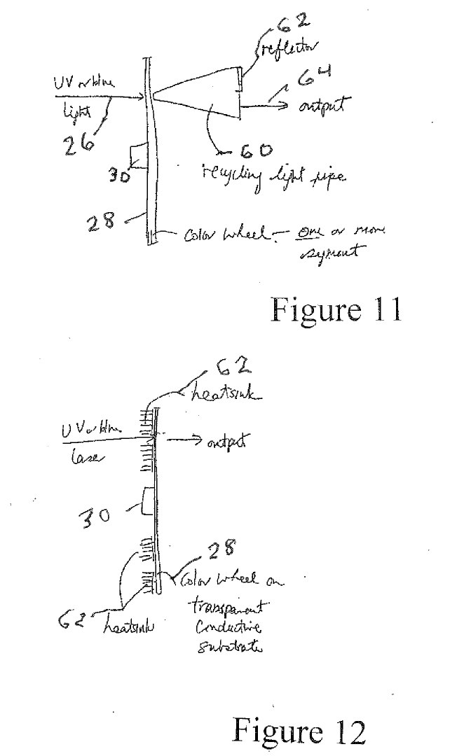

FIG. 11 shows another alternative of a color wheel system. The color wheel 28 includes one or more sectors. Light generated by the phosphor or phosphors of the one or more sectors enters a tapered light pipe 60 at the smaller end of the pipe 60. A reflector 62 is disposed at the larger end of the pipe 60 to reflect a portion of the light back onto the color wheel 28 such that the output 64 leaving the pipe 60 has greater brightness.

The use of recycling in the color wheel systems of FIGS. 10 and 11 is especially useful when higher power laser source is needed, in which the etendue of the phosphor emission area is larger than the system etendue. Recycling reduces the etendue of the system and increases the brightness.

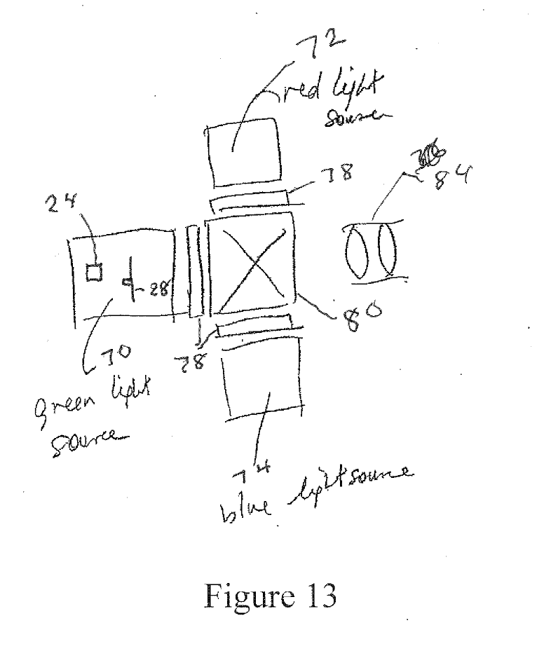

As the excitation power of the laser increases, there is a chance that the phosphor may overheat and reduce efficiency. FIG. 12 shows another embodiment of a color wheel system in which the color wheel 28 is equipped with heat sinks 62 such that heat generated by the phosphor is dissipated effectively. In the case of FIG. 12, the phosphor or phosphors are coated onto a color wheel which is a highly conductive and transparent substrate.

FIG. 13 shows another projector which operates in a manner analogous to a 3LCD projector. A conventional 3LCD projector uses a single light source of white light. The light passes through dichroic mirrors which separate the white light into red, green, and blue light. Each color light is projected through an LCD panel, where individual pixels are opened or closed to allow light through or block it in order to form an image of that color. The separate colors are then converged using another prism to form the final, three-color image, which is projected on to the screen.

The projector of FIG. 13 uses three colored light sources, for example a green light source 70, a red light source 72, and a blue light source 74. Each light source passes through an LCD panel 78 to produce three images. The images are converged using a prism 80 and projected outwardly through lenses 84 in the same manner as the three images in a 3LCD projector are converged and projected.

Typically, a stronger green light is needed to provide white balance. To do so, preferably the green light source is a blue laser 24 which uses a single sector color wheel 28 covered in a phosphate which converts the blue laser light beam into green light. The red and blue light sources are preferably LEDs. However, if desired each color light source may operate with its own laser and phosphor. Also, a recycling collar or light pipe, as described in the previous embodiments, may be used to increase the brightness of the laser and LEDs.

Recycling of white LED light has a higher efficiency than of colored light. Thus, the single color wheel 28 can be coated with white phosphor. The output can be recycled and collimated. A green filter can be used to filter the white light output to become a green light output. Optionally, a reflective polarizer can be used for polarization recycling to further increase the output brightness of the system.

Although the foregoing embodiments utilize a laser-pumped phosphor for color emission, other materials can be used such as quantum dots or other phosphorescent materials.

Preferably, a short wavelength laser is used to excite phosphors that emit longer wavelengths. By way of example, a UV or blue laser can excite blue, green, and red phosphor. A different class of materials can absorb long wavelength and emit shorter wavelength using up-conversion. An infra-red laser can be used to excite up-conversion materials to emit red, green, and blue light. The above embodiments can be used with such up-conversion materials by replacing the blue lasers with long wavelength lasers and replacing the phosphors with up-conversion materials.

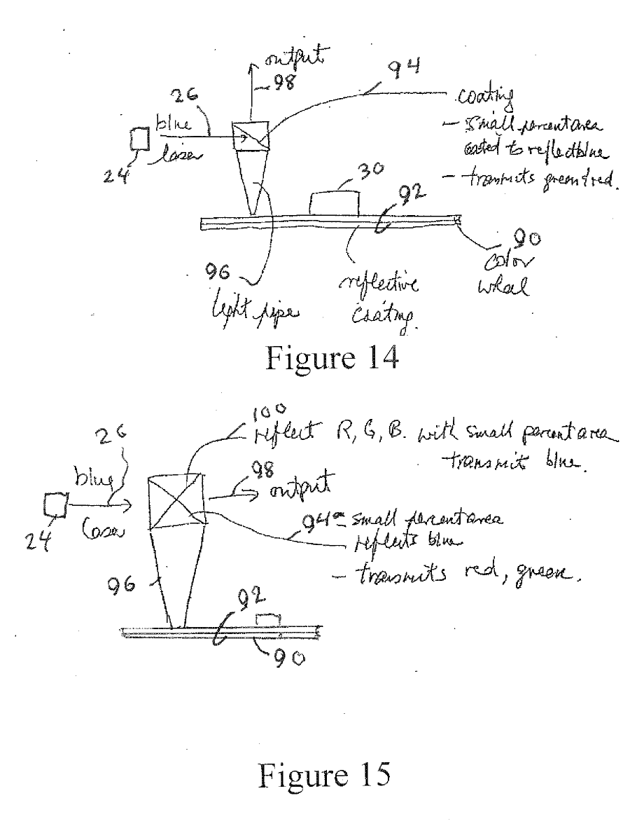

In the embodiment of a color wheel shown in FIG. 14, a reflective material 92 is provided on the color wheel 90 such that the excitation blue laser 24 is placed on the top side and the output also emits to the top side. More particularly, since the size of the laser beam is small, the laser beam travels along the path 26 to a beam splitter 94, a small percentage of which is coated to reflect the full extent of the small laser beam towards the color wheel 90 by way of a tapered light pipe 96, and to transmit green and red through the output 98 of a tapered light pipe 96. The reflective material 92 can be metal coated with a reflective coating. This provides a better heat sink for the phosphor materials to produce better efficiency at high power. In addition, in the use of a reflective color wheel, in which the laser 24 and output 98 are located on the same side of the color wheel 90, allows the color wheel 90 to be placed horizontally within the projector housing, reducing the height of the projector.

The blue (or UV or infra-red) laser is directed to a reflector or beam splitter cube 94 coated as described above. The laser light will be directed to the phosphor layer on the color wheel 90 through the light pipe 95. The output emission 98 is directed back into the light pipe and exits through the reflector or beam splitter 94 as shown in the figure as a red, green or blue output 98, depending upon which color phosphor is below the light pipe end adjoining the color wheel 90.

FIG. 15 shows another configuration where the input and output are on the same side of the color wheel 90. Again, a small beam of blue light is generated by a laser 24 and transmitted to a beam splitter cube with a first coated element 94a which has a small percentage area covering the full extent of the laser beam, that reflects blue toward the color wheel 90. The element 94a transmits red and green to the output 98. The beam splitter cube includes a second coated element 100 that reflects red, green, and blue from the color wheel towards the output 98. A small percentage of the area of the element 100 is coated so as to transmit the full extent of the blue laser beam.

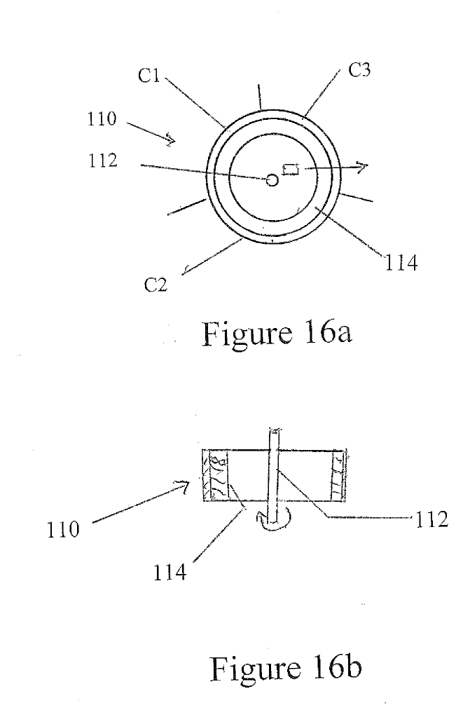

The color wheel 110 shown in FIGS. 16a and 16b has generally a cylindrical outer wall and rotates about a drive 112 which rotates perpendicular to the cylinder. The phosphor materials and diffusion material are deposited on the outer surface of the cylindrical outer wall. In the example, the outer cylindrical wall has three sectors with coatings C1, C2, and C3. Coating C1 is a red phosphor, coating C2 is a green phosphor, and coating C3 is a blue phosphor or a clear or diffusive coating. The cylindrical outer surface may, if desired, be divided into more than three sectors. In embodiments where the laser light is transmitted through a diffuse coating, the speckle effects will be minimized.

The color wheel 110 may also take a transmissive or reflective configuration. In the case of a tranmissive configuration, the cylindrical outer wall 114 is made of a transparent material, e.g., glass or sapphire. The wall 114 may also be made of clear plastic for lower power applications. The laser 116 is placed in the interior of the cylinder to project light in a predetermined direction 118. Recycling configurations, such as shown in FIGS. 10 and 11, may be employed.

In the case of a reflective configuration, the cylindrical outer wall 114 is preferably made of metal or another material with good thermal conductivity. A laser configuration similar to that used in FIG. 14 or 15 may be employed.

The foregoing description represents the preferred embodiments of the invention. Various modifications will be apparent to persons skilled in the art. All such modifications and variations are intended to be within the scope of the invention, as set forth in the following claims.

1. A projector comprising:
a laser for forming blue, UV, or infra-red light;
a rotatable color wheel having at least one sector coated with a phosphor or up-conversion material for converting such blue light into green light;
a source of red light and a source of blue light;
at least one imaging device positioned to receive, directly or indirectly, the green, red and blue light for forming a green, red, and blue portions of an image to be projected;
and projection optics for receiving the green, red, and blue portions for projecting the image.

2. The projector of claim 1, wherein said color wheel has at least three sectors, wherein a second sector is coated with a second phosphor for converting blue light into red light, and a third sector includes a diffuser for transmitting blue light as diffused blue light.

3. The projector of claim 2, wherein the red, green, and blue light are transmitted sequentially to a single imaging device in the form of an imaging panel for forming and transmitting to the optics, sequentially, the red, green, and blue portions of the image.

4. The projector of claim 3, further comprising a light pipe or a compound parabolic concentrator (“CPC”) for receiving the output from the color wheel and transmitting such output towards the imaging panel.

5. The projector of claim 1, wherein said color wheel has at least three sectors, wherein a second sector is opaque and a third sector includes a diffuser for transmitting blue light as diffused blue light; wherein said projector further includes a red LED and optics for transmitting sequentially red, blue and green light to the imaging device depending upon the rotational position of the color wheel.

6. The projector of claim 5, the light output from the color wheel extends at least generally in an axial direction; wherein the red LED is positioned to emit red light generally at an angle to the axial direction; and further comprising a filter positioned along the axial direction to reflect red light from the red led to extend in the axial direction while allowing green and blue light from the color wheel to pass through the filter.

7. The projector of claim 6, wherein the red LED is synchronized to emit red light only when the opaque sector of the color wheel receives light output from the laser.

8. The projector of claim 1, further comprising a plurality of additional lasers for generating blue light, wherein said laser and additional lasers directing such light onto a common location on the color wheel.

9. The projector of claim 5, further comprising a tapered light pipe or CPC for receiving the output from the color wheel and transmitting such output towards the imaging panel.

10. The projector of claim 1, wherein at least one sector of the color wheel includes a filter element between the laser and the phosphor or diffuser to transmit UV or blue light and reflect green and red light.

11. The projector of claim 1, further including a mounting device for the color wheel for changing the position of the color wheel at least vertically.

12. The projector of claim 1, further comprising a recycling collar having in inwardly curved reflective surface and an aperture, wherein said collar is positioned to receive the output from the color wheel for passing colored beams through the aperture and reflecting beams that impact the inwardly curved surface back to the color wheel.

13. The projector of claim 1, further comprising a tapered light pipe having a smaller end for receiving the output from the color wheel and a larger end for discharging light, wherein the larger end includes a reflector for reflecting some of the light back to the color wheel.

14. The projector of claim 1, wherein the color wheel includes heat sink elements for absorbing a portion of any heat generated by the UV or blue laser light.

15. The projector of claim 1, further comprising a first light source which includes said laser and color wheel for generating only green light, a second light source for generating only red light, and a third light source for generating only blue light; and further comprising an imaging device for each light source to create a green, red, and blue portion of an image; and wherein the projection optics comprises a prism for receiving and combining the green, red, and blue image portions to be projected as a single image.

16. The projector of claim 1, wherein the color wheel includes upper and lower faces and a reflective coating on the lower face; wherein the laser transmits blue or UV light through a filter in a first direction to the upper face for forming the green, red, and blue colors, and wherein the color wheel thereafter reflects the colors and transmits the colors back in a direction which is opposite to the first direction.

17. The projector of claim 1, wherein the color wheel has a cylindrical outer surface coated with a plurality of phosphor or up-conversion materials.

18. The projector of claim 17, wherein said cylindrical outer surface is transmissive and said laser is positioned within said outer surface.

19. The projector of claim 17, wherein said cylindrical outer surface is reflective.
